(19) United States
(12) Patent Application Publication
(10) Pub. No.: US 2020/0122528 A1
(43) Pub. Date: Apr. 23, 2020

(54) Crawler

(71) Applicant: Continental Reifen Deutschland GmbH, Hannover (DE)

(72) Inventors: Joerg Lehmann, Hannover (DE); Thorsten Koehler, Deuerling (DE); Karl-Heinz Eglseder, Maxhuette (DE)

(73) Assignee: Continental Reifen Deutschland GmbH, Hannover (DE)

(21) Appl. No.: 16/493,832

(22) PCT Filed: Jan. 18, 2018
(86) PCT No.: PCT/EP2018/051149

§ 371 Date: Sep. 13, 2019

(30) Foreign Application Priority Data
Mar. 14, 2017 (DE) 10 2017 204 172.2

(51) Int. Cl. B60C 23/04; B60C 11/24

(52) U.S. Cl. CPC B60C 23/0479; G01M 17/02; B60C 11/243; B60C 11/246

(57) ABSTRACT

A crawler for capturing and determining state parameters or state data of vehicle tires mounted on a vehicle, with
a vehicle chassis with at least two axles and at least three wheels or with a chain or caterpillar drive,
a drive system (3) with at least one electric motor and a rechargeable battery pack,
an electronic vehicle controller (4),
a communication unit (5) for receiving data from a backend and for transmitting data to a backend,
a sensor system (6) with receivers for receiving data from sensors installed in the tires and with sensors for capturing state parameters at the outside of the tires.

The invention relates to a crawler for capturing and determining state parameters or state data of vehicle tires mounted on a vehicle.

For the sake of a long service lifetime of vehicle tires, in particular pneumatic vehicle tires on all kinds of vehicle, it is necessary to keep the tires in condition and to check their state regularly in that, above all, the internal tire pressure, the current profile depth, the state of the side wall on the outside of the vehicle and also the regularity of the abrasion of the tread are checked. Damage to vehicle tires can also be ascertained during this check. Checking the state of tires on vehicles that belong to a vehicle fleet or car pool is associated with a considerable outlay in terms of time and personnel. The person charged with monitoring the tires here goes from vehicle to vehicle, manually checks the internal tire pressure, usually also manually measures the profile depth, and performs a visual check.

Using crawlers to inspect pipelines is known and usual. Two types of crawler are used for this purpose: those that travel along the inside of the pipeline, which means that the transfer of the fluid must be interrupted, and those which carry out their inspection journeys along the outside of the pipeline. A crawler of the second type is known, for example, from U.S. Pat. No. 7,594,448 B2. This crawler has a vehicle chassis with four wheels, a drive system, and an electronic unit with various components matched to the intended application.

The invention is based on the object of providing a crawler for the capture and determination of the current state of vehicle tires mounted on vehicles, which significantly reduces the outlay in terms of time and personnel for inspection of the vehicle tires.

The object addressed is achieved according to the invention by a crawler with
a vehicle chassis with at least two axles and at least three wheels or with a chain or caterpillar drive,
a drive system with at least one electric motor and a rechargeable battery pack,
an electronic vehicle controller,
a communication unit for receiving data from a backend and for transmitting data to the backend,
a sensor system with receivers for receiving data from sensors installed in the tires and with sensors for capturing state parameters at the outside of the tires.

The crawler according to the invention thus performs the tasks of the otherwise necessary control person, thus significantly lowers the costs, performs the intended inspections reliably, and thereby increases the security of documentation. The crawler additionally makes it possible to carry out monitoring at arbitrary time intervals and at arbitrary times.

In one possible form of embodiment of the crawler according to the invention, it is equipped for movement and control by means of remote control. Remote control systems that come into question are known per se, for example for the remote control of model aircraft or model cars.

In a further embodiment of the crawler according to the invention, it is equipped for movement and control by means of FPV (First Person View). Such control systems are also usual, for example in RC model construction for cars, aircraft, helicopters and the like. The first-person perspective is achieved here through a camera located on the crawler whose signals are transmitted via a transmitter to a receiver for RC pilots. The signals are appropriately converted and the images of the camera are displayed in real time on, for example, a monitor or via video glasses.

In a further advantageous form of embodiment, the crawler is provided with a unit for accurate location determination, in particular in order to carry out automatic movement on the basis of location data stored in the vehicle controller or received during operation.

The unit for accurate location determination can carry out a determination of location in different ways, again known per se, for example by means of GPS, in particular differential GPS. The location finding can, further, proceed by means of laser, radar or camera sensors or by means of special transmitting units that operate with UWB technology or BNE technology.

The communication unit of the crawler according to the invention is connected to the backend—the central office or the operator—wherein this connection can be a radio connection or can take place over Wi-Fi, Bluetooth, LoRa or mobile telephony.

The crawler according to the invention should, above all, be capable of capturing and saving, processing and/or transmitting the data or parameters important for monitoring and control of the tire state. The crawler is therefore equipped with a sensor system to which at least one camera with image sensors belongs, in particular in order to enable an external visual monitoring of the tires, of preparing corresponding recordings and transmitting them to the backend or saving them. The sensor system comprises at least one profile depth sensor to ascertain the current profile depth of the respective vehicle tire. In addition, the sensor system can comprise at least one RFID reader as a receiver for reading in data of an RFID transponder installed in the tire. These data permit, for example, a unique association between tire and vehicle. If internal pressure sensors are installed in the tires to be monitored, it is advantageous if the sensor system also comprises a receiver for reading in the data of the internal pressure sensors.

The sensor system can, furthermore, comprise sensors for environment recognition, for example at least one camera, an ultrasonic system or a radar system. A travel path recognition can be carried out in this way, or obstacles can be recognized and avoided.

The crawler according to the invention can, further, be fitted with a signal processing unit which evaluates the data captured and stored from the various sensors of the sensor system while still on board.

In order to avoid accidents with persons or other vehicles, it is advantageous if the crawler is fitted with at least one optical and/or at least one acoustic warning apparatus.

Further features, advantages and details of the invention will now be described in more detail with reference to the drawing which shows an exemplary embodiment of the invention schematically. Here

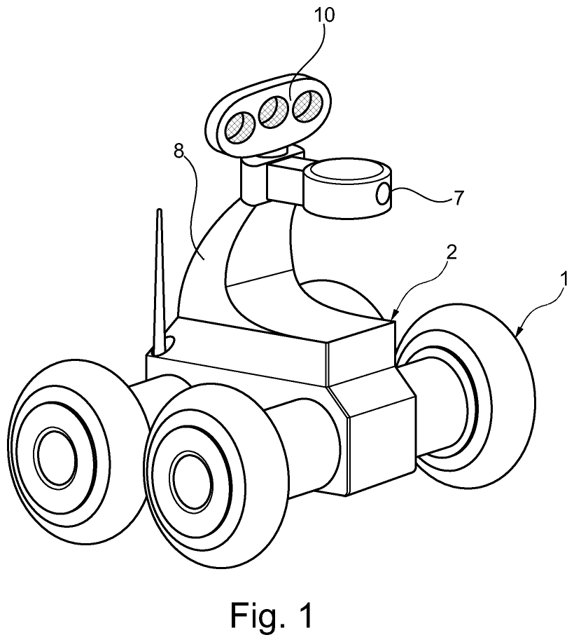

FIG. 1 shows a view of an embodiment of a crawler according to the invention, and

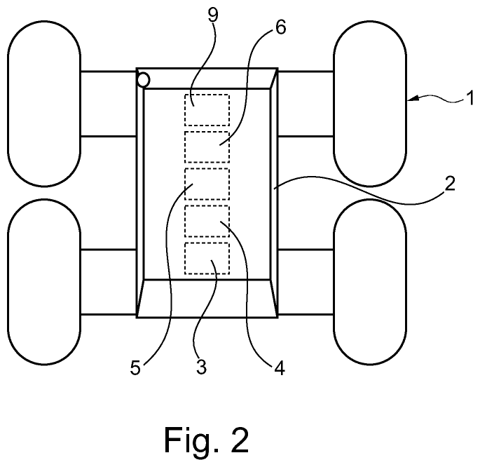

FIG. 2 shows a plan view of the crawler without add-on components.

The crawler according to the invention is provided and equipped to monitor and capture the state of tires on motor vehicles of a vehicle fleet or a carpool, for example of a carpool of organizations, companies, authorities or military units. It should be possible above all for the internal tire pressure, the profile depth, preferably also the external state of the side wall and the abrasion pattern of the tread of the tire, whether regular or irregular, as well as any damage to the outer side of the tire to be ascertained.

The crawler illustrated in FIG. 1 only schematically and by way of example, comprises a vehicle chassis with, in the exemplary embodiment, two axles and four wheels 1. The crawler can, however, also comprise more than two axles, for example three axles, and therefore six wheels. Embodiments with two axles and three wheels, or with a chain or caterpillar drive, are also possible. The vehicle chassis, which is implemented in such a manner that the crawler is steerable and can drive around bends, carries a housing 2 in which important components of the crawler are housed, and which are suggested schematically in FIG. 2. A drive system 3 with one or a plurality of electric motor(s) for carrying out the travel movements of the crawler, in particular for driving forwards, driving in reverse and driving around bends, as well as for actuating the steering, belong to these components. A chargeable battery pack is provided for energy supply. An electronic vehicle controller 4, by means of which the crawler can be moved automatically and/or under remote control, is a further component. For a possible remote control, the crawler can, for example, be manually controlled by sight by an operator by means of the transmitter. In addition or as an alternative it can be provided that the crawler is controlled by means of FPV (First Person View). Analog signals are here transmitted in real time from a camera attached to the crawler to the operator and displayed on a monitor, for example on a notebook or in video glasses, so that the operator can control the crawler directly.

In the case of an automatic operation of the crawler, path points along which the crawler travels are stored in a computing unit in the vehicle controller 4. It can be provided here that the crawler remains in a waiting position at particular path points for a defined period of time, for example between 1 and 2 minutes, in order, perhaps, to carry out monitoring measurements or in order to search specifically for objects by means of a camera mounted on the crawler. The unit for accurate location determination which is required for automatic operation is located, in particular, in the vehicle controller 4, and can take place by means of GPS, in particular differential GPS, through location finding or through surveying by means of laser, radar or camera sensors or by means of special transmitting units making use of UWB (Ultra Wide Band) technology or BLE (Bluetooth Low Energy) technology. Other satellite-based location-finding systems can be used instead of GPS.

A communication unit 5 which is connected, in particular via a radio connection, for example Wi-Fi, Bluetooth, LoRa (Long Range Wide Area Network) or mobile telephony to a backend—the in particular stationary central operation office—where further information on the current mission may be available, is a further electronic component of the crawler. This information can, for example, be maps of a fleet yard, a workshop hall or the like. The radio connection provided also serves to transmit measurement data that have been ascertained for evaluation at the backend.

The crawler furthermore has a sensor system 6 with a number of sensors and/or receivers for measurement signals or data.

The sensor system 6 therefore comprises in particular at least one camera 7 with image sensors that are located on a structure 8 which is preferably adjustable in height and pivotable, as well as a sensor for determining the profile depth of the tire tread (profile depth sensor). The sensor system 6 further has a receiver, for example an RFID reader, in order to receive data from an RFID transponder installed in the tire, so that tires and vehicle can be uniquely associated, and further has a receiver for receiving the signals of an internal pressure sensor installed in the tire. The external visual monitoring is performed by means of the image sensor(s) of the camera. The captured data are stored and either sent to the backend via the communication unit 5 for evaluation, or are evaluated and assessed while still on board in an appropriate signal processing unit 9.

The sensor system 6 can, in addition, have sensors for environment recognition, for example at least one camera, an ultrasonic system or radar, in order, for example, to recognize the travel path or to notice obstacles, and furthermore a warning apparatus 10, for example at least one lamp and/or an acoustic signal transducer. A charging station which the crawler visits in good time and autonomously can, in addition, be provided for the battery pack. The crawler can furthermore be fitted with solar cells for charging the battery pack. The provided lamp can also be used for illuminating the tires in order to ensure a good quality of picture recording.

### LIST OF REFERENCE SIGNS

1 . . . Wheel
2 . . . Housing
3 . . . Drive system
4 . . . Vehicle controller
5 . . . Communication unit
6 . . . Sensor system
7 . . . Camera
8 . . . Superstructure
9 . . . Signal processing unit
10 . . . Warning apparatus

1.-14. (canceled)

15. A crawler for monitoring and capturing a state of one or more vehicle tires, the crawler comprising:
a vehicle chassis with at least two axles and at least three wheels or with a chain or caterpillar drive;
a drive system with at least one electric motor and a rechargeable battery pack;
an electronic vehicle controller;
a communication unit for receiving data from a backend and for transmitting data to the backend; and
a sensor system having one or more receivers for receiving data from one or more sensors installed in the tires and with the one or more sensors for capturing state parameters at the outside of the tires.

16. The crawler as claimed in claim 15, equipped for movement and control by means of a remote control.

17. The crawler as claimed in claim 15, equipped for movement and control by means of a FPV (First Person View).

18. The crawler as claimed in claim 15, comprising a unit for accurate location determination wherein the location determination is stored in the vehicle controller and the electronic vehicle controller is configured automatic movement of the crawler based on the location determination.

19. The crawler as claimed in claim 18, wherein the unit for accurate location determination uses global positioning system (GPS).

20. The crawler as claimed in claim 15, wherein the communication unit is connected to the backend via a radio connection.

21. The crawler as claimed in claim 20, wherein the communication unit is connected to the backend via one or more of Wi-Fi, Bluetooth, LoRa or mobile telephony.

22. The crawler as claimed in claim 15, wherein the sensor system comprises a profile depth sensor.

23. The crawler as claimed in claim 15, wherein the sensor system comprises at least one camera with image sensors.

24. The crawler as claimed in one of claim 15, wherein the sensor system comprises at least one radio-frequency identification (RFID) reader as a receiver for reading in data of an RFID transponder installed in the tire.

25. The crawler as claimed in claim 15, wherein the sensor system comprises a receiver for reading in data of an internal pressure sensor installed in the tire.

26. The crawler as claimed in claim 15, wherein the sensor system comprises one or more sensors for environment recognition and includes one or more of at least one camera, an ultrasonic system and/or a radar system.

27. The crawler as claimed in claim 15, further comprising a signal processing unit that evaluates the data captured and stored by the sensor system.

28. The crawler as claimed in claim 15, further comprising at least one optical and/or at least one acoustic warning apparatus.

29. A crawler for capturing and determining state parameters or state data of vehicle tires mounted on a vehicle, the crawler comprising:
a vehicle chassis;
a drive system coupled to the vehicle chassis and having at least one motor;
an electronic vehicle controller coupled to the drive system; and
a sensor system for receiving data from one or more sensors installed in the vehicle tires.

30. The crawler of claim 29, wherein the chassis comprises one or more axles.

31. The crawler of claim 29, wherein the chassis comprises one of a chain or a caterpillar drive.

32. The crawler of claim 29, wherein the drive system further comprises a rechargeable battery pack configured to supply energy to the at least one motor.

33. The crawler of claim 32, further comprising one or more solar cells configured to charge the rechargeable battery pack.

34. The crawler of claim 29, wherein the electronic vehicle controller is configured to operate the crawler to travel along a plurality of path points and carry out monitoring measurements based on location of the crawler with respect to the plurality of path points.

35. The crawler of claim 29, further comprising a communication unit coupled to the electronic vehicle controller and a processing unit, wherein the communication unit is configured to connect to a central operation office and receive mission information from the central operation office and the processing unit is configured to evaluate the received data obtained by the sensor system.
